(19) United States
(12) Patent Application Publication
(10) Pub. No.: US 2010/0306253 A1
(43) Pub. Date: Dec. 2, 2010

(54) Tiered Managed Storage Services

(75) Inventors: Russell Perry, Bristol (GB); David Stephenson, Chippenham (GB)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/473,552

(22) Filed: May 28, 2009

(51) Int. Cl. G06F 17/30; G06F 9/46

(52) U.S. Cl. 707/770; 718/100; 707/805; 707/600

(57) ABSTRACT

Systems and methods for managed access to tiered storage are disclosed. One such system comprises a plurality of storage systems and a tier manager. Each storage system implements a tier selected from the group of online and other than online. The tier manager is configured to ensure that a specified file is available on a specified tier, responsive to a client request.

### BACKGROUND

Tiered storage systems attempt to reduce total storage cost by using higher cost, low-latency storage in the top tier, and higher latency lower cost storage in the lower tier(s). Files are moved between tiers according to a storage policy or algorithm, or upon an administrator request. Because these systems provide a file system abstraction to applications, applications typically experience significant delays when accessing a file in the lowest tiers, and applications do not always handle this gracefully.

Another type of storage solution, referred to as “storage as a service”, utilizes storage in a remote location that is available over the Internet. Storage-as-a-service uses an explicit interface for reading and writing, rather than the file system abstraction. However, large files can take a long time to transfer between remote locations using the public web. This introduces a significant degree of latency, which applications do not always handle gracefully. The long transfer time also increases the risk of transfer errors.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of a system including a computing device which implements tiered managed storage services, according to one embodiment disclosed herein.

FIG. 2 is a block diagram of one embodiment of the tiered managed storage server of FIG. 1

FIG. 3 is a block diagram of another embodiment of the tiered managed storage server of FIG. 1.

FIG. 4 is a block diagram of yet another embodiment of the tiered managed storage server of FIG. 1.

FIG. 5 is a block diagram of another embodiment of a system including the tiered managed storage server of FIG. 1.

FIG. 6 is a block diagram of yet another embodiment of a system including the tiered managed storage server of FIG. 1.

FIG. 7 is a flow chart of a process implemented by some embodiments of the tiered managed storage server of FIG. 1.

FIG. 8 is a flow chart of a process implemented by some embodiments of the tiered managed storage server of FIG. 1.

FIG. 9 is a block diagram of a tiered managed storage server of FIG. 1, according to some embodiments disclosed herein.

### DETAILED DESCRIPTION

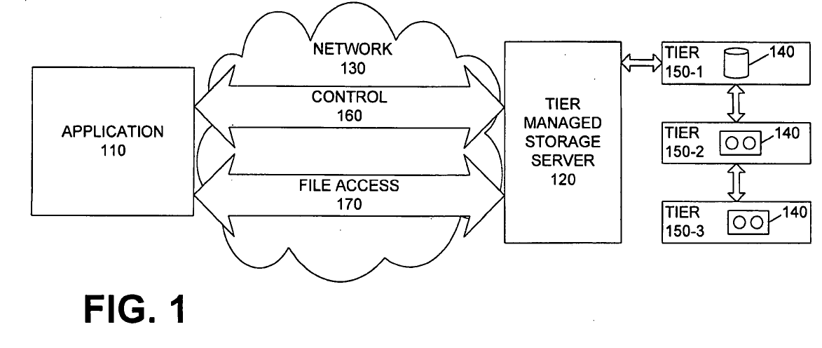

FIG. 1 is a block diagram of a system including a computing device which implements tiered managed storage services. Application 110 communicates with a tiered managed storage server 120 over a network 130. In various embodiments of the system, network 130 takes the form of (for example) the Internet, an intranet, a wide area network (WAN), a local area network (LAN), a wireless network, another suitable network, etc., or any combination of two or more such networks. Tiered managed storage server 120 provides application 110 with managed access to files on various storage devices and/or storage systems 140, which are arranged in tiers 150. These tiers are differentiated by factors such as latency, mean time between failure (MTBF), service level agreement, cost, location, or combinations thereof. Tiers 150 are coupled, for example, through a bus or network such as FiberChannel. More than one storage device/system can be included in a particular tier, and various numbers of tiers can be supported.

A tier can be categorized as either online, providing immediate access to files, or not online, providing delayed rather than immediate access to files. In the embodiment of FIG. 1, the not online (e.g., other than online) group of tiers is further subdivided into nearline and offline. Thus, in this example there are three tiers: online (150-1); nearline (150-2); and offline (150-3). Online tier 150-1 provides immediate access to files. Access to files in nearline tier 150-2 may be somewhat delayed rather than immediate, and typically does not require human intervention. Finally, access to files in offline tier 150-3 is even more delayed, and may involve manual intervention. In some embodiments, online, nearline and offline are classes of tiers, such that more than one tier can exist in a class.

Conventional tiered storage systems use a file system abstraction, where an application using a conventional file system application interface (e.g., open, read, write, close, etc.) to access files stored on a tier. Movement of a file between tiers takes place according to a policy. The location of a file is generally transparent to an applications using a file, except that an open operation for an offline tier takes much longer than an open for the other tiers.

In contrast, tiered managed storage server 120 gives application 110 control, through a control interface 160, over which tier 150 a file is stored on, and for how long. This recognizes that in many usage scenarios, applications are best positioned to understand which files will be needed as the application executes, and to preemptively copy files to appropriate storage. As one example, an application that performs batch processing over a set of old records that are normally archived offline would first request the files to be copied to an online (low latency) tier.

Using the techniques described herein, application 110 uses control interface 160 to request that a particular file be made available on specified tier during a particular time period, using a mechanism referred to herein as a “lease”. An online lease has the specific property that, once the online is obtained for a particular file, application 110 can use a file access interface 170 provided by tiered managed storage server 120 to read/download that file from online tier 150-1. File access interface 170 thus takes the place of the file system abstraction which a conventional tiered storage system provides for read access by a client. An online or nearline lease (which results in the file being present on online tier 150-1 or nearline tier 150-2, respectively) avoids the latency that would be incurred if the same file was stored instead only on offline tier 150-3. In some embodiments, use of file access interface 170 on a file not present on the tier requested in the lease returns an indication that the file is not yet available on that tier. In other embodiments, if application 110 uses file access interface 170 on a file not present on the tier requested in the lease, tiered managed storage server 120 makes a best effort to supply the file data (e.g., from storage on the pre-lease tier).

Storage devices used to implement online tier 150-1 are typically random access. Examples include hard disk, memory, and hybrids such as flash drive, where hard disk encompasses various forms such as redundant array of disks (RAID), and storage area network (SAN), etc. and memory encompasses various forms such as random access memory (RAM). Storage devices used to implement nearline tier 150-2 are typically sequential, rather than random, access. Examples include tape drive, optical disk drive, etc. Some embodiments of nearline tier 150-2 include aggregations of drives, for example, a robotic library containing multiple drives to allow multiple concurrent read and writes and a slot for inserting or removing media from the library-to retrieve from/store on shelves. Another embodiment uses a web-based storage service (e.g., “cloud storage” or “storage as a service”) to implement nearline tier 150-2. Offline tier 150-3 is implemented as media (e.g., tapes or optical disks) that is stored outside of a drive (e.g., on a shelf or in a bin). Some sort of intervention is needed to copy media from offline tier 150-3 to one of the other tiers. In some embodiments, this intervention involves a human operator. One such embodiment involves a human operator that responds to a request to move a particular media instance by physically retrieving the media from a shelf and inserting it into a nearline tape library. Other embodiments are more automated, for example, an automated warehouse that locates a particular media instance on a shelf, robotically moves the media from the shelf to a postbox, where the media is picked up from the postbox and robotically inserted into the tape library. In either case, if the requested file is to be moved online, tiered managed storage server 120 takes further action to copy the file from tape to disk.

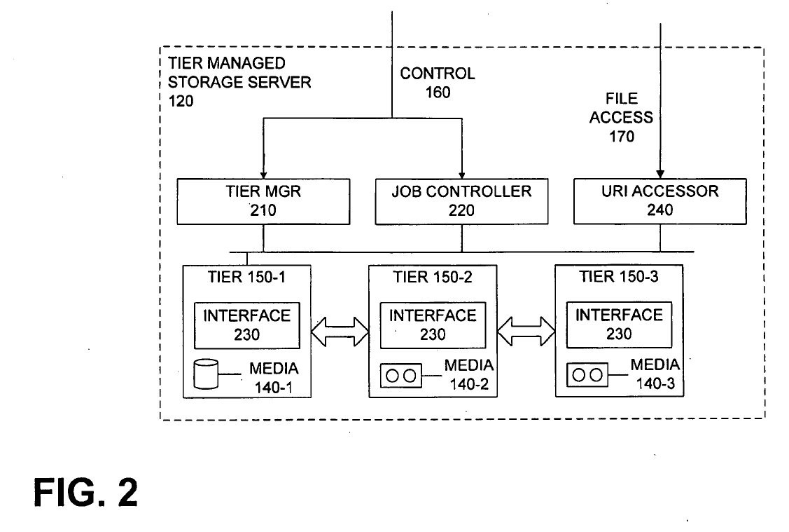

FIG. 2 is a block diagram of one embodiment of tiered managed storage server 120. As described earlier in connection with FIG. 1, tiered managed storage server 120 includes control interface 160 and file access interface 170. Incoming requests through control interface 160 are dispatched to a tier manager component 210 or a job controller component 220, for handling that is appropriate to the request. Tier manager 210 is configured to provide various status functions (e.g., which tier a file is currently stored on, status of a lease, etc.). In some embodiments, these status functions return to the caller immediately with the requested information, but an asynchronous implementation is also possible. Tier manager 210 is also configured to handle requests to ensure that a specified file is available on a specified tier, in response to a client request (through the lease mechanism, as mentioned above). Tier manager 210 relies on a storage media-specific interface 230 to perform the move from one tier to another. The embodiment of FIG. 2 includes three different storage types (disk, tape library, and shelf), so three different interfaces 230 are present.

In the embodiment of FIG. 2, since file movement is an operation of relatively long duration, tier manager 210 uses an asynchronous job abstraction provided by job controller 220 to effect movement of files. When a request to move a file comes in via web service interface 520, tier manager 210 creates a job representing the file movement request. Tier manager 210 then completes the caller application's request, Indicating whether or not the job creation was successful, and starts the job. Job controller 220 then notifies the caller application (asynchronously) when the job completes, if the caller provided a callback with the initial file move request. In some embodiments, job controller 220 also sends events describing progress of an ongoing job to the caller. In addition to functions to create and manage jobs, job controller 220 also provides functions status and maintenance functions (e.g., get status of job, cancel job, update priority of job, etc.).

As discussed above, tiered managed storage server 120 does not use a file system abstraction. Instead, file access interface 170 is implemented by a uniform resource identifier (URI) accessor component 240. (As described above, some embodiments of storage server 120 do not permit application 110 to use file access interface 170 to read a particular file until an online lease is obtained, which avoids application errors due to timeouts on file operations.) Several implementations of storage server 120 are contemplated, differing in which entity is responsible for moving data. In a “passive accessor” implementation, storage server 120 is “passive” because client application 110 moves the file data. With a passive accessor, client application 110 obtains a resolvable URI from URI accessor 240. Client application 110 then uses this URI to either “pull” the file data from the server (analogous to a file read from the client's perspective) or to “push” the file data to the server (analogous to a file write from the client's perspective). In an “active accessor”, storage server 120 is “active” because URI accessor 240 moves the file data. With an active accessor, client application 110 provides a resolvable URI to URI accessor 240. URI accessor 240 then uses this URI to either “push” the file data to the client (analogous to a file write from the server's perspective) or to “pull” the file data from the client (analogous to a file read from the server's perspective).

In either case, resolution of the URI results in invocation of a transfer protocol which in turn copies the file to, or from, one of the tiers 150 that is managed by ter managed storage server 120. Some embodiments of URI accessor 240 support hypertext transfer protocol (HTTP), other embodiments support file transfer protocol (FTP), and still other embodiments support both. Other protocols are contemplated as well. In some of these passive accessor embodiments, the returned accessor URIs are dynamically computed by tiered managed storage server 120 according to generation rules. URIs should be understood by a person of ordinary skill in the art, and will not be discussed in further detail.

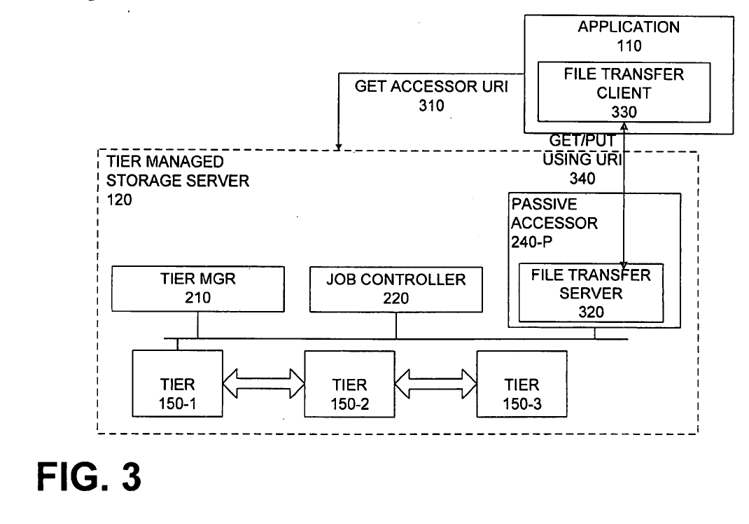

FIG. 3 is a block diagram of an embodiment of tiered managed storage server 120 which uses a passive URI accessor. The embodiment shown in FIG. 3 uses the same components from FIG. 2, except that passive URI accessor 240-P replaces (generic) URI accessor 240. FIG. 3 also shows interaction between client application 110 and passive URI accessor 240-P. Specifically, application 110 calls a GetAccessorURI function (310), which returns a URI. Use of a passive accessor by client application 110 is limited to the lease duration, because when the lease expires the content is no longer guaranteed to be accessible from online tier 150-1. Since usage patterns involving a lease followed by file access are typical, some embodiments of storage server 120 support a single request which combines a lease and a GetAccessorURI 310.

The URI returned by GetAccessorURI 310 resolves to a file transfer server 320 associated with passive URI accessor 240-P. A file transfer client 330 associated with client application 110 uses the URI to contact file transfer server 320 and initiate a file transfer (340) for a particular file. A pull (GET) transaction copies the file from online tier 150-1 to client application 110, while a push (PUT) transaction copies the file from client application 110 to online tier 150-1.

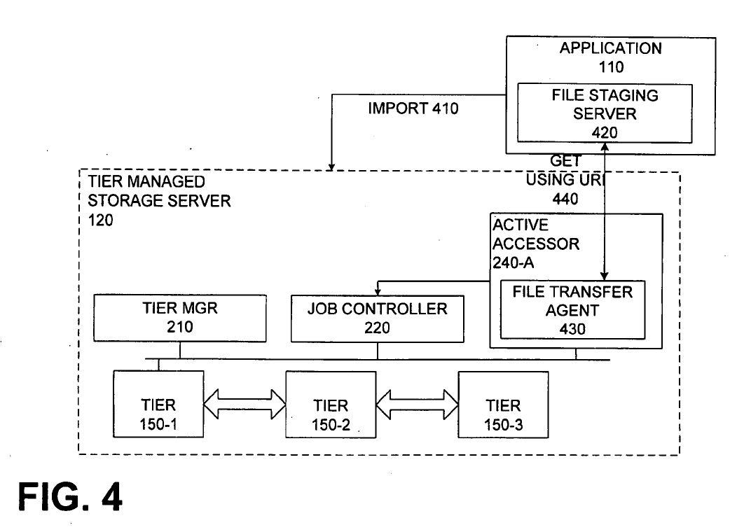

FIG. 4 is a block diagram of an embodiment of tiered managed storage server 120 which uses an active URI accessor. The embodiment shown in FIG. 3 uses the same components from FIG. 2, except that an active URI accessor 240-A replaces (generic) URI accessor 240. A transfer from client to server proceeds as follows. Client application 110 calls an Import function (410) to direct tiered managed storage server 120 to pull a particular file from a staging server 420 (specified by a URI) associated with client application 110. In response to Import 410, a file transfer agent 430 associated with accessor 240-A performs a GET transaction (440) to copy the file from staging server 420 to online tier 150-1.

A transfer from server to client proceeds as follows. Client application 110 calls an Export function (not shown) to direct tiered managed storage server 120 to push a particular file from staging server 420 (specified by a URI). In response to the Export, a file transfer agent 430 performs a PUT transaction (not shown) to copy the file from online tier 150-1 to staging server 420. Once the file has been transferred to staging server 420, application 110 uses a conventional mechanism to access the file (e.g., Network File Service (NFS), local disk, etc.)

In some embodiments, active URI accessor 240-A creates a job to perform a file transfer, and invokes file transfer. agent 430 when resources are available for the job (e.g., processor cycles, storage bus bandwidth, network bandwidth, etc.) In some embodiments, a file transfer job is made up of multiple GET transactions.

The active accessor model of FIG. 4 differs from the passive model of FIG. 3 in several ways. First, the active model allows tiered managed storage server 120 to execute requests from multiple applications in parallel, and to determine the optimum number of requests to parallelize. Next, with storage server 120 driving the data transfer in the active model, more than one thread can be used to speed up the import/export. Another difference is that the import and export of the active model can be implemented in a fail-over manner: since storage server 120 directs the transfer, another file transfer agent 430 can continue from where the failed file transfer agent 430 had stopped. Yet another difference is that in the active model, storage server 120 can set priorities on imports and exports to allow-high priority jobs to overtake lower priority jobs in the queue. Still another difference is that the active model allows storage server 120 to ensure that online tier 150-1 is never exhausted by too many large files being accessed at once. Finally, when jobs are used with the active model, programmatic access to in-progress jobs allows for status monitoring and the ability to kill jobs.

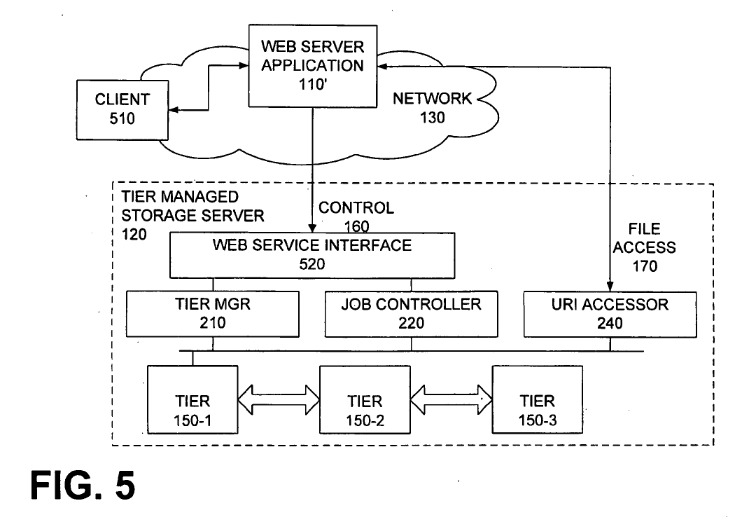

FIG. 5 is a block diagram of another system including tiered managed storage server 120, one that uses web services. In this embodiment, application 110 from FIG. 1 is a web server application 110′ which locates and communicates with tiered managed storage server 120, on behalf of client application 510 (e.g., a browser). Thus, the front end to control interface 160 of tiered managed storage server 120 is a web service interface 520. Incoming requests through control interface 160 are dispatched to control interface 160 and file access interface 170, as described earlier in connection with FIGS. 24. Similarly, web service Interface 520 returns the response to a particular request back to the caller. A person of ordinary skill in the art should be familiar with web services, and so further details will not be discussed.

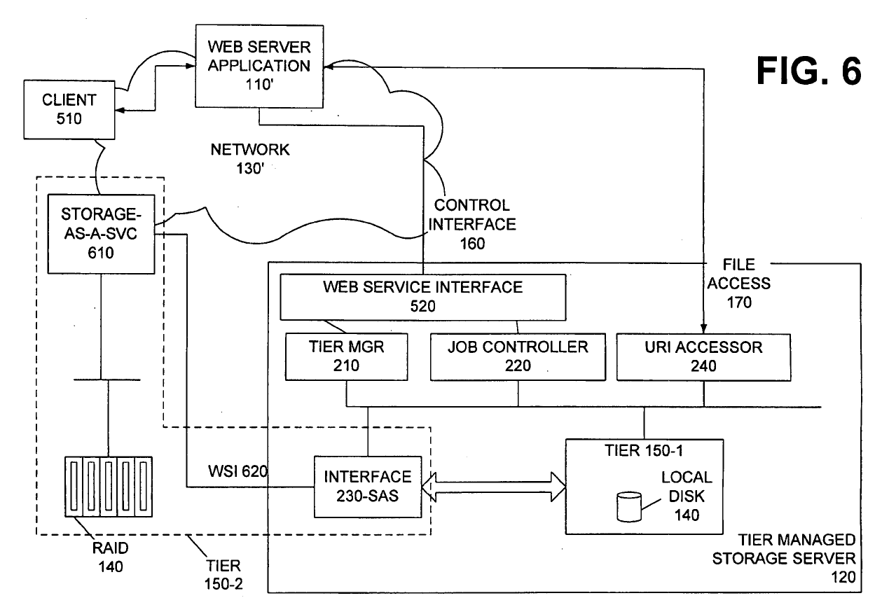

FIG. 6 is a block diagram of another system including tiered managed storage server 120, one that uses storage-as-a-service to implement a tier. The components in this diagram are the same as in FIG. 5, except that two tiers are involved instead of three, and only one tier (150-1) Is local to tiered managed storage server 120. Storage for the second tier is remote from storage server 120 and implemented through a web-based storage service 610 (also known as “storage as a service”), accessible over web service interface 620. As described earlier in connection with FIG. 2, each tier is associated with a storage-specific interface. In this embodiment, storage server 120 implements storage interface 230-SAS, which uses web service interface (WSI) 620 to move files between tiered managed storage server 120 and storage devices (e.g., RAID disk 140) located at the remote site. Tier 150-2 can thus be viewed as the combination of storage interface 230-S and storage service 610. A person of ordinary skill in the art should be familiar with web-based storage services, and so further details will not be discussed.

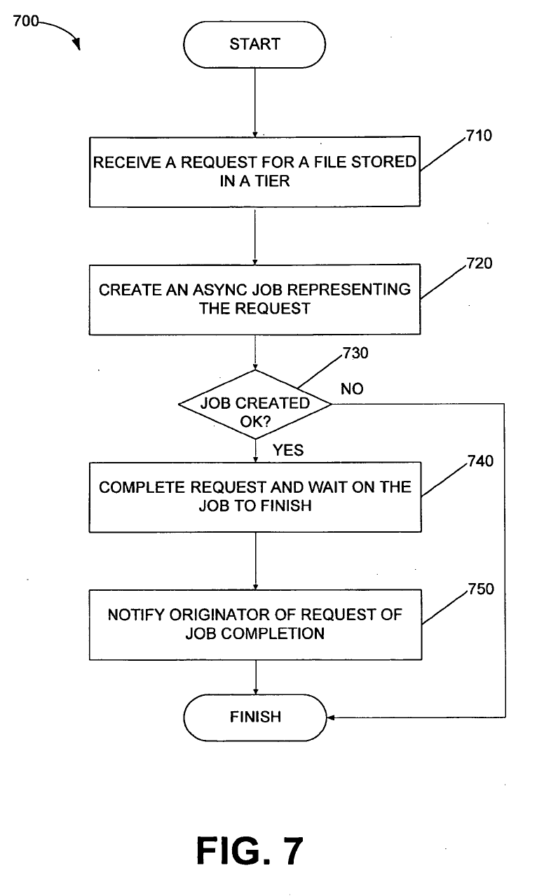

FIG. 7 is a flow chart of a process for managing tiered storage, implemented by some embodiments of tiered managed storage server 120. Process 700 begins at block 710, where a request associated with a file stored in a ter is received. In some embodiments, this request is received via a web service. At block 720, after the request is received, process 700 creates a job which represents the file request. At block 730, process 700 determines whether the job was created successfully. If not, process 700 returns with an error. Otherwise, process 700 completes the request immediately then waits on the job to complete (block 740). Upon job completion, at block 750 the originator of the request is notified that the job has completed, either successfully or with an error. Process 700 is then finished.

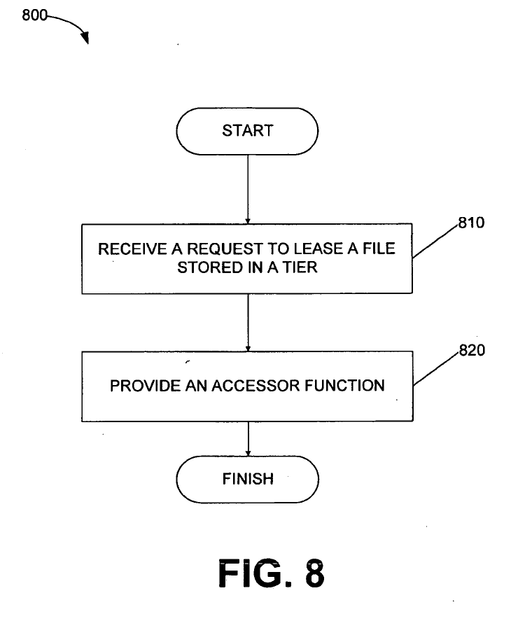

FIG. 8 is a flow chart of a process for ensuring access to a file on tiered storage, implemented by some embodiments of tiered managed storage server 120. Process 800 begins at block 810, where a request to lease a specified file is received. In some embodiments, this request is received via a web service. As described above, the lease specifies (implicitly or explicitly) the tier to which the file is to be moved. In some embodiments, process 700 determines before moving whether the file is already present on the requested tier, so that an unnecessary copy of the file is not performed. In some embodiments, the lease specifies a class or group of tiers (e.g., online). In other embodiments, the lease indicates a specific tier in a specific group (e.g., tier “RAID-1” of the online tiers). The lease also specifies (implicitly or explicitly) the schedule, time period, and/or duration of the least.

At block 820, after the request is received, process 700 provides an accessor function. Once the file has been moved or copied to the tier specified by the lease, the accessor function can be used by an originator of the lease to retrieve the file. Process 700 is then finished.

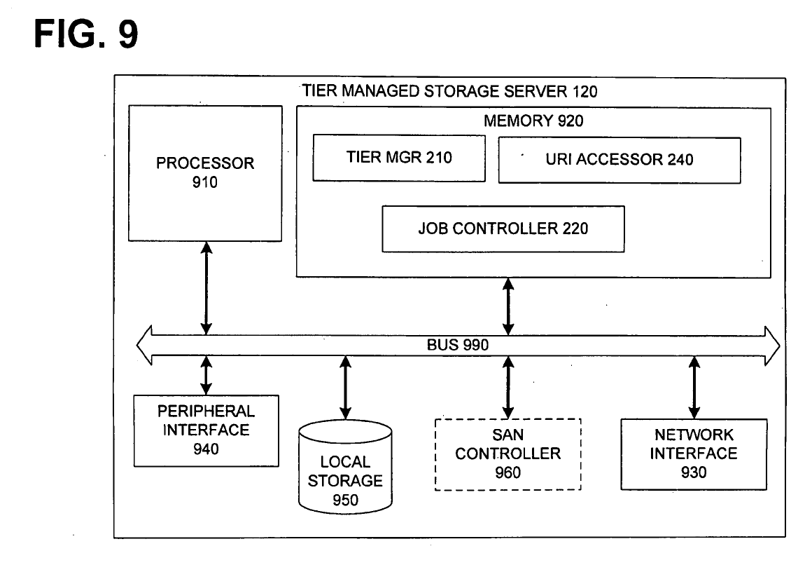

FIG. 9 is a block diagram of a tiered managed storage server 120, according to some embodiments disclosed herein. Server 120 includes a processor 910, memory 920, a network interface 930, a peripheral input output (I/O) interface 940, a local storage device 950 (e.g., non-volatile memory or a disk drive), and an (optional) storage area network controller 960 which provides an interface to one or more network-accessible storage devices. These hardware components are coupled via a bus 970. Omitted from FIG. 9 are a number of components that are unnecessary to explain the operation of server 120.

Tier manager 210, job controller 220, and URI accessor 240 can be implemented in hardware logic, software (i.e., instructions executing on a processor), or a combination thereof. Hardware implementations include (but are not limited to) a programmable logic device (PLD), programmable gate array (PGA), field programmable gate array (FPGA), an application-specific integrated circuit (ASIC), a system on chip (SoC), and a system in package (SiP). In a software implementation, memory 920 stores various software components which are executed by processor 910, for example, tier manager 210, job controller 220, and URI accessor 240.

These executable components can be embodied in any computer-readable medium for use by or in connection with any processor which fetches and executes instructions. In the context of this disclosure, a “computer-readable medium” can be any means that can contain or store the program for use by, or in connection with, the processor. The computer readable medium can be based on electronic, magnetic, optical, electromagnetic, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) an optical fiber and a portable compact disk read-only memory (CD-ROM).

The software components illustrated herein are abstractions chosen to illustrate how functionality is partitioned among components in some embodiments of various systems and methods of deferred error recovery disclosed herein. Other divisions of functionality are also possible, and these other possibilities are intended to be within the scope of this disclosure. Furthermore, to the extent that software components are described in terms of specific data structures (e.g., arrays, lists, flags, pointers, collections, etc.), other data structures providing similar functionality can be used instead.

Software components are described herein in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Software components referred to herein include executable code that is packaged, for example, as a standalone executable file, a library, a shared library, a loadable module, a driver, or an assembly, as well as interpreted code that is packaged, for example, as a class. In general, the components used by the systems and methods for handling access violations are described herein in terms of code and data, rather than with reference to a particular hardware device executing that code. Furthermore, the systems and methods can be implemented in any programming language, and executed on any hardware platform.

The flow charts herein provide examples of the operation of various software components, according to embodiments disclosed herein. Alternatively, these diagrams may be viewed as depicting actions of an example of a method implemented by such software components. Blocks in these diagrams represent procedures, functions, modules, or portions of code which include one or more executable instructions for implementing logical functions or steps in the process. Alternate embodiments are also included within the scope of the disclosure. In these alternate embodiments, functions may be executed out of order from that shown or discussed, including substantially concurrently or in reverse order, depending on the functionality involved. Not all steps are required in all embodiments.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and describe in order to best explain the principles of the invention and its practical applications, to thereby enable others skilled in the art to best utilize the invention and various embodiments with various modifications as are suited to the particular use contemplated.

What is claimed is:

1. A system for managed access to tiered storage, the system comprising:
a plurality of storage systems, each storage system implementing a tier selected from the group of online and other than online; and
a tier manager configured to ensure that a specified file is available on a specified tier, responsive to a client request.

2. The system of 1, wherein the specified tier is an online tier.

3. The system of 1, wherein the other than online tier group includes a nearline tier and an offline tier.

4. The system of 1, wherein the tier manager is further configured to determine whether the file is already available on an online tier at the time of the client request, and if not, to move the file to the online tier.

5. The system of 4, further comprising a job controller configured to provide an asynchronous job abstraction, wherein the tier manager uses the job abstraction to move the file to the online tier.

6. The system of 1, further comprising a web service interface coupled to the tier manager.

7. The system of 1, wherein the client request specifies a time period during which the tier manager ensures that the specified file is available on the specified tier.

8. The system of 1, further comprising:
a file accessor configured to provide an accessor function through which the specified file can be read/written upon another client request.

9. The system of 8, wherein the file accessor function returns a uniform resource identifier (URI).

10. The system of 8, wherein the file accessor function returns a uniform resource identifier (URI) which is located within the system.

11. The system of 1, wherein the another client request fails if the client request is not made prior to the another client request.

12. The system of 8, wherein the client request and the another client request are combined into a single request.

13. A method for managing tiered storage, the method comprising:
receiving a request, via a web service, associated with a file stored in one of a plurality of tiers;
responsive to the request:
creating an asynchronous job representing the request;
responsive to successful creation of the asynchronous job, completing the request;
starting the asynchronous job;
responsive to the completion of the asynchronous job, notifying the originator of the request that the asynchronous job has completed.

14. The method of 13, further comprising:
starting the asynchronous job when resources for the asynchronous job become available.

15. The method of 13, wherein the request corresponds to moving the associated file to an online one of the tiers.

16. A method for ensuring access to a file on tiered storage, the method comprising:
receiving a request to lease a file that is stored in one of a plurality of tiers, the lease effective for a specified time period, the lease resulting in the presence of the leased file on a specified one of the tiers during the specified time period;
after the lease request, providing an accessor function through which the leased file can be read by an originator of the request.

17. The method of 16, wherein a call by the originator to the accessor function that is made without obtaining a lease provides an Indication when the requested file is not present on the specified one of the tiers.

18. The method of 16, further comprising:
deleting the file from the specified one of the tiers responsive to expiration of the specified time period.

19. The method of 16, further comprising:
preventing movement of the leased file from the specified one of the tiers to a different one of the tiers during the specified time period.

20. The method of 16, further comprising:
copying the leased file to the specified one of the tiers before the specified time period begins.
